(19) United States
(12) Patent Application Publication
(10) Pub. No.: US 2004/0211523 A1
(43) Pub. Date: Oct. 28, 2004

(54) Adhesive tape cutter hung on a girdle

(76) Inventor: Hsiu-Man Yu Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/422,986

(22) Filed: Apr. 25, 2003

(51) Int. Cl. B32B 31/00; B44C 7/04

(52) U.S. Cl. 156/523; 156/527; 156/577

(57) ABSTRACT

An adhesive tape cutter hung on a girdle includes a clamping member and a holding plate, therefore the adhesive tape cutter can be hung on a girdle or held by hand for carrying out cutting of an adhesive tape. A stop plate is provided to fix an adhesive tape roll on an adhesive tape base to prevent the adhesive tape roll from moving backward. Thus, a user can employ the adhesive tape cutter either by hanging it on the girdle or holding it with a hand according to practical needs in operation.

### BACKGROUND OF THE INVENTION

1. Field of the Invention

This invention relates to an adhesive tape cutter, particularly to one able to be hung on a user's girdle, convenient in use and able to prevent an adhesive tape from moving backward.

2. Description of the Prior Art

One kind of conventional adhesive tape cutter having an adhesive tape fitted thereon is commonly placed on a flat surface for use. Another kind of conventional adhesive tape cutter 1, as shown in FIG. 1, has an adhesive tape holder 2 provided with a handle 3, an adhesive tape base 4 and a cutting device 5. Certainly, the latter conventional adhesive tape cutter having the handle 3 held to carry out cutting of an adhesive tape is more practical and convenient than the former one which is placed on a flat surface for use.

However, the conventional adhesive tape cutter 1 with the handle 3 can only be held by a user's hand to move around and carry out cutting of an adhesive tape, unable to be hung on a girdle for use.

### SUMMARY OF THE INVENTION

The objective of the in vent ion is to offer an adhesive tape cutter able to be hung on a user's girdle or held by a user's hand to carry out cutting of an adhesive tape, provided with a stop plate to prevent an adhesive tape from moving backward when it is cut off and having two tape-outgoing modes for a user to choose for use.

### BRIEF DESCRIPTION OF DRAWINGS

This invention will be better understood by referring to the accompanying drawings, wherein:

FIG. 1 is a perspective view of a conventional adhesive tape cutter:

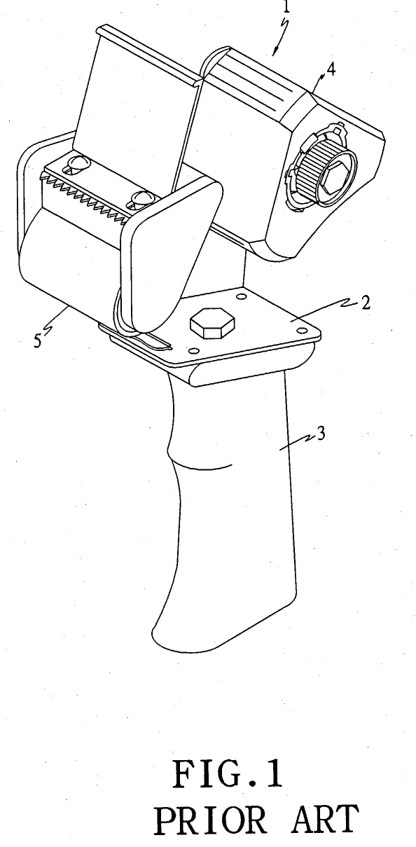

FIG. 2 is a perspective view of an adhesive-tape cutter hung on a girdle in the present invention:

FIG. 3 is an exploded perspective view of the adhesive tape cutter hung on a girdle in the present invention:

FIG. 4 is a cross-sectional view of the stop plate of the adhesive tape cutter hung on a girdle in an operating condition in the present invention:

FIG. 5 is a perspective view of a first embodiment of the cutting device of the adhesive tape cutter hung in a girdle in an operating condition in the present invention: and

FIG. 6 is perspective view of a second embodiment of the cutting device of the adhesive tape cutter hung on a girdle in an operating condition in the present invention.

### DETAILED DESCRIPTION OF DRAWINGS

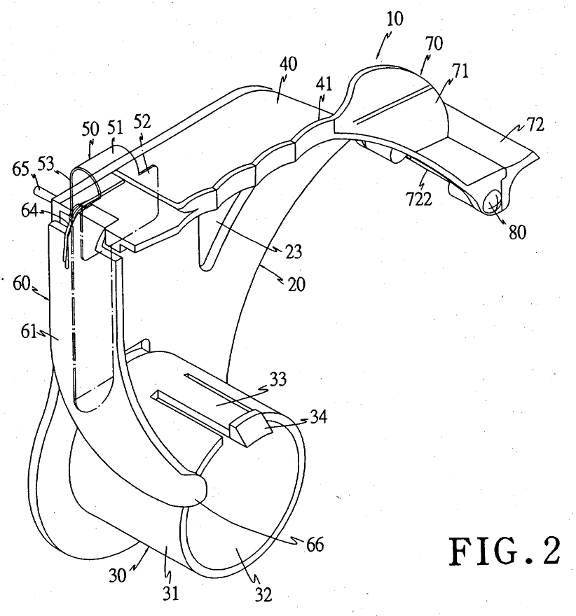

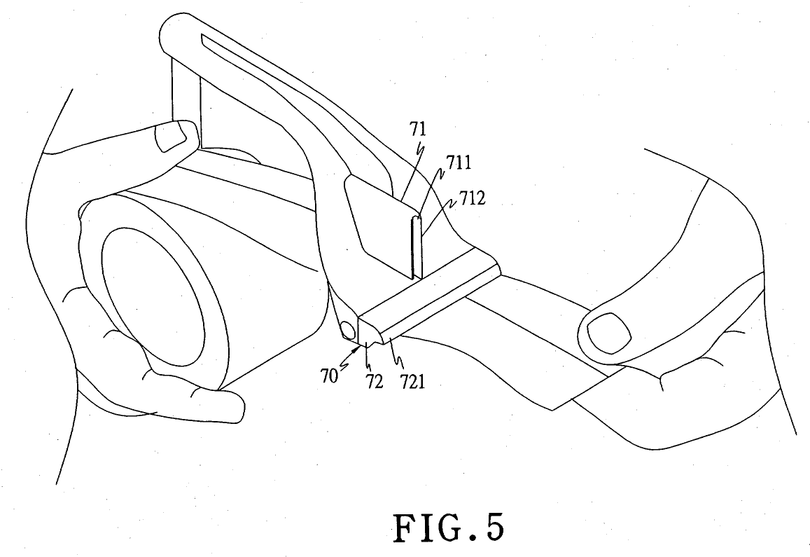

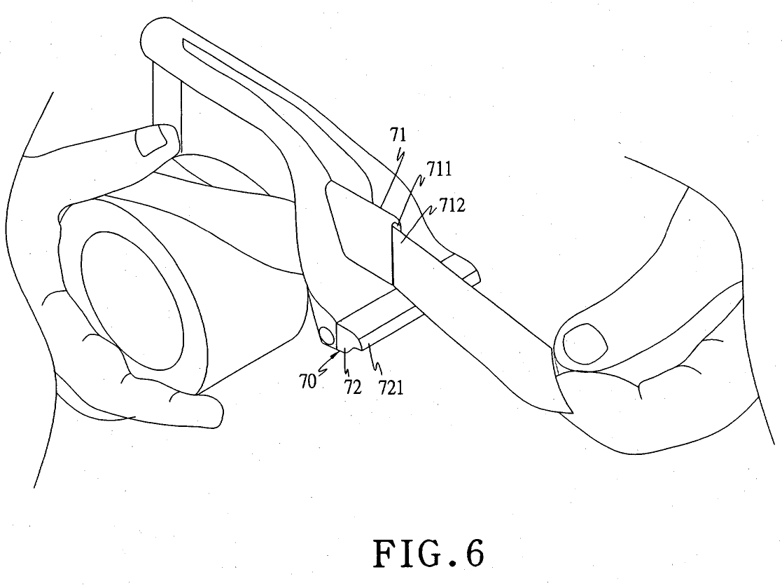

A preferred embodiment of an adhesive tape cutter 10 hung on a girdle in the present invention, as shown in FIGS. 2-6, includes a side plate 20, an adhesive tape base 30, a holding plate 40, a clamping member 50, a stop device 60 and a cutting device 70 as main components combined together.

The side plate 20 is bored at the rear side with two engage grooves 21 corresponding to each other and respectively having a downward opening. Each engage groove 21 has a projecting lip 22 formed at the lower end. A holding hole 23 is formed the center portion of the side plate 20 in front of the two engage grooves 21 for receiving a user's thumb therein.

The adhesive tape base 30 is shaped a cylinder 31 positioned at the lower front side of the side plate 20. The cylinder 31 is formed with an insert hollow 32 in the center and a connecting plate 33 laterally formed on its upper circumference and having its inner end connected with the cylinder 31 and its outer end forming a free end having preset flexibility. Besides, the connecting plate 33 has its outmost end formed with an engage projection 34 for fixing an adhesive tape roll on the adhesive tape base 30.

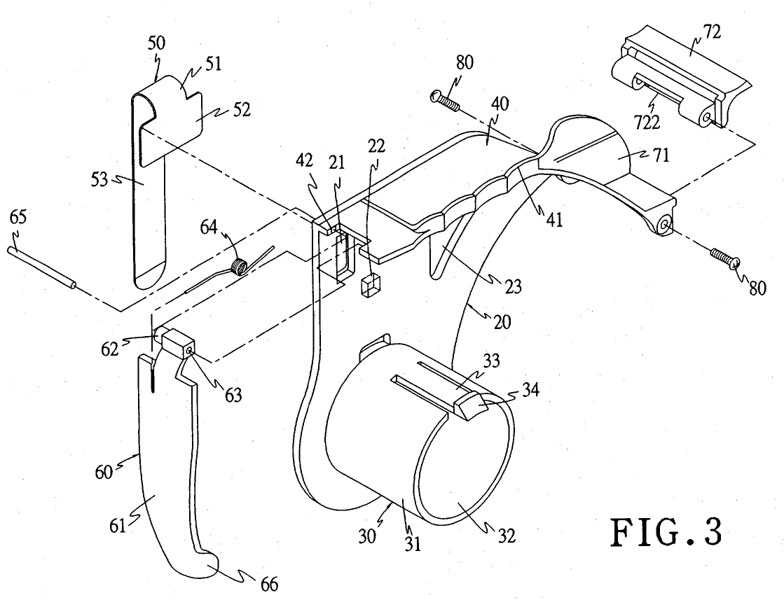

The holding plate 40 is flatly formed on the top of the side plate 20, extending outward horizontally and having its outer edge formed with a corrugated holding lip 41. Thus, a user can hold the corrugated holding lip 41 of the holding plate 40 and the holding hole 23 of the side plate 20 with his fingers and carry the adhesive tape cutter about. Besides, the holding plate 40 has two connecting holes 42 facing each other and respectively formed at the opposite protruding ends of its rear side, as shown in FIGS. 2 and 3.

The clamping member 50 is positioned at the rear side of the side plate 20, having a U-shaped plate 51 formed with an elastic rectangular engage plate 52 at the right side to be fitted in the two engage grooves 21 of the side plate 20 from the bottom to the top, with the bottom of the rectangular engage plate 52 held by the top ends of the two projecting lips 22 to let the clamping member 50 fixed in the engage grooves 21 of the side plate 20. The engage plate 52 extends backward to form a clamp 53 with a preset curve for facilitating the adhesive tape cutter to be hung on a girdle and carried about, as shown in FIG. 2.

The stop device 60 is positioned at the rear side of the holding plate 40, having a stop plate 61 formed with a support rod 62 on top. The support rod 62 is axially bored with an insert hole 63, with a twist spring 64 fitted around the support rod 62. A fixing pin 65 has one end inserted in the connecting hole 42 of the holding plate 40 and the outer end inserted in the insert hole 63 of the support rod 62 of the stop plate 61 and riveted. Besides, the stop plate 61 has its lower end curved to extend outward and formed with a stop rib 66 for fixing an adhesive tape roll on an adhesive tape base 30, as shown in FIGS. 2 and 3.

The cutting device 70 positioned at the front end of the holding plate 40 is formed with a vertical tape-outgoing plate 71 extending outward at the front end of the holding-plate 40, and having an elongate slot 711 bored in the center and a vertical blade 712 provided at the outer side. The cutting device 70 is also provided with a lateral tape-outgoing plate 72 having opposite sides fixed with the vertical tape-outgoing plate 71 by bolts 80. The lateral tape-outgoing plate 72 is provided with a lateral blade 721 at the outer end, and a pasting rod 722 is provided under the lateral blade 721 for an adhesive tape to be temporarily adhered thereon.

The adhesive tape cutter in the invention can be held for use by a user 's hand respectively with the thumb inserted in the hold hole 23 of the side plate 20 and the other four fingers holding the corrugated holding lip 41 of the holding plate 40. The adhesive tape cutter in the invention can also be hung on a user's girdle for use by means of the clamp 53 of the clamping member 50. To carry out pasting, the adhesive tape fitted on the adhesive tape cutter 10 is pulled outward to extend by one hand and the holding plate 40 is stably held by the other hand of a user to prevent the adhesive tape cutter 10 from slipping side ward, easy in operating and convenient in use.

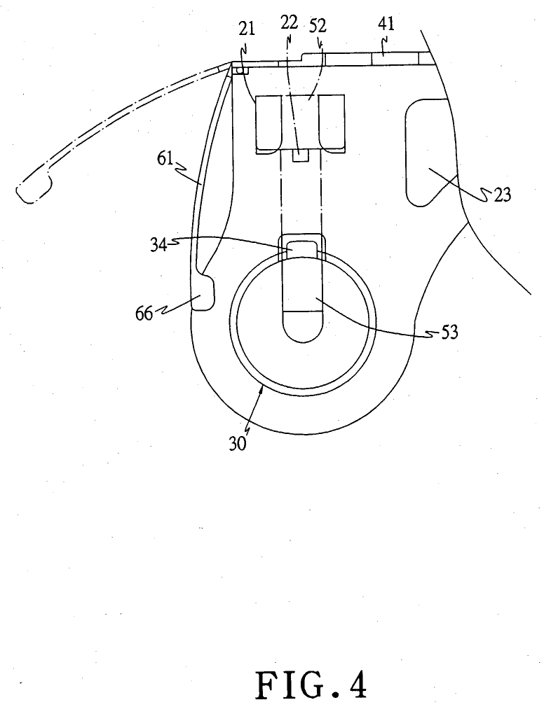

Specifically, the stop plate 61 of the stop device 60 has its upper end fixed at the rear side of the holding plate 40 by a fixing pin 65, and the twist spring 64 is fitted on the support rod 62 of the stop plate 61 with one end pushing against the holding plate 40. Thus, after the stop plate 61 is pushed outward from the position A to the position A′, as shown in FIG. 4, and an adhesive tape roll is fitted around the cylinder 31 with its adhesive tape positioned, the stop plate 61 will be moved to its original position together with the twist spring 64, and the stop rib 66 of the stop plate 61 can stop the adhesive tape roll from slipping and falling off, and the stop plate 61 can prevent the adhesive tape from moving backward after used, enabling the adhesive tape accurately pulled outward to a required length for use and convenient in handling.

The cutting device 70 is provided with the vertical tape-outgoing plate 71 and lateral tape-outgoing plate 72. The vertical tape-outgoing plate 71 is bored with the elongate slot 711 for an adhesive tape to pass therethrough. To carry out pasting, the adhesive tape is pulled outward to extend through the elongate slot 711 and be pasted on the vertical tape-outgoing plate 71 or fixed temporarily on the pasting rod 722 of the lateral tape-outgoing plate 72. In using, the adhesive tape is pulled outward to a needed length and, after used it is cut off by the vertical blade 712. Besides, the lateral blade 721 can be straight or serrated for a user to choose for cutting an adhesive tape, all depending on material of the adhesive tape and practical needs.

While the preferred embodiment of the invention has been described above, it will be recognized and understood that various modifications may be made therein and the appended claims are intended to cover all such modifications that may fall within the spirit and scope of the invention.

I claim:

1. An adhesive tape cutter hung on a girdle comprising a side plate, an adhesive tape base, a holding plate, a clamping member, a stop device and a cutting device: and characterized by:
Said side plate having two engage grooves bored at the rear side, two projecting lips respectively positioned under said two engage grooves, said side plate provided with a holding hole in front of said two engage grooves for receiving a user's thumb therein:
Said holding plate having its outer edge formed with a corrugated holding lip, said corrugated holding lip of said holding plate and said holding hole of said side plate facilitating an adhesive tape cutter to be held and carried about by a user's hand:
Said clamping member formed with a U-shaped plate, said U-shaped plate formed with an engage plate at the right side, said engage plate engaging in said two engage grooves of said side plate, said engage plate held in position by said two projecting lips under said engage grooves to let said clamping member fixed in said engage grooves, said engage plate extending backward and forming a clamp, said clamp facilitating an adhesive tape cutter to be hung on a girdle: and
Said stop device formed with a stop plate, said stop plate provided on top with a support rod having an insert hole, said support rod fitted thereon with a twist spring, said support rod fixed on the rear side of said holding plate by a fixing pin, said stop plate formed with a stop rib at the lower end, said stop rib fixing an adhesive tape roll on an adhesive tape base.

2. The adhesive tape cutter hung on a girdle as claimed in claim 1, wherein said cutting device is provided with a vertical tape-outgoing plate at the front end of said hold plate, and said vertical tape-outgoing plate is provided with a vertical blade for cutting an adhesive tape.

3. The adhesive tape cutter hung on a girdle as claimed in claim 1, wherein said cutting device is provided with a lateral tape-outgoing plate having a lateral blade on the outer end, and a pasting rod positioned under said lateral blade for an adhesive tape to be temporarily adhered thereon.

4. The adhesive tape cutter hung on a girdle as claimed in claim 1, wherein said lateral blade is straight.

5. The adhesive tape cutter hung on a girdle as claimed in claim 1, wherein said lateral blade is serrated.
